(19) United States
(12) Patent Application Publication
(10) Pub. No.: US 2021/0293237 A1
(43) Pub. Date: Sep. 23, 2021

(54) Momentum Pump Apparatus

(71) Applicant: Jason Pierce, Tooele, UT (US)

(72) Inventor: Jason Pierce, Tooele, UT (US)

(21) Appl. No.: 16/823,668

(22) Filed: Mar. 19, 2020

(51) Int. Cl. F04C 2/18; F04C 2/08

(52) U.S. Cl. CPC F04C 2/18; F04C 15/008; F04C 2/084; F04C 2/086

(57) ABSTRACT

A momentum pump apparatus for mechanically pumping fluids includes a pump housing defining a housing inside. A housing front side has a fill aperture extending through to the housing inside. A housing back side has a supply aperture extending through to the housing inside. A fluid line is coupled within the pump housing and is in fluid communication with the supply aperture and the fill aperture. A pump is coupled within the pump and is in fluid communication with the fluid line to bring fluid from the supply aperture to the fill aperture. A gear system is coupled within the pump housing and includes a weighted disc to maintain momentum once spinning. The gear system is in operational communication with the pump. A handle assembly is coupled to the pump housing and is in operational communication with the gear system to operate the pump.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pump devices and more particularly pertains to a new pump device for mechanically pumping fluids.

### (2) Description of Related Art Including Information Disclosed Under 37 CFR 1.97 and 1.98

The prior art relates to pump devices. Existing pump devices come in many forms and many are hand powered. However, these devices lack internal gearing and momentum gathering weight discs to continue pumping while the hand is not in action.

### BRIEF SUMMARY OF THE INVENTION

An embodiment of the disclosure meets the needs presented above by generally comprising a pump housing having a housing front side, a housing back side, a housing left side, a housing right side, a housing top side, and a housing bottom side defining a housing inside. The housing front side has a fill aperture extending through to the housing inside. The housing back side has a supply aperture extending through to the housing inside. A fluid line is coupled within the pump housing. The fluid line is in fluid communication with the supply aperture and the fill aperture. A pump is coupled within the pump and is in fluid communication with the fluid line to bring fluid from the supply aperture to the fill aperture. A gear system is coupled within the pump housing. The gear system includes a weighted disc to maintain momentum once spinning. The gear system is in operational communication with the pump. A handle assembly is coupled to the pump housing and is in operational communication with the gear system to operate the pump.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a momentum pump apparatus according to an embodiment of the disclosure.

FIG. 2 is a side elevation view of an embodiment of the disclosure.

FIG. 3 is a side elevation view of an embodiment of the disclosure.

FIG. 4 is a side elevation view of an embodiment of the disclosure.

FIG. 5 is a detail view of an embodiment of the disclosure.

FIG. 6 is a front elevation view of an embodiment of the disclosure.

### DETAILED DESCRIPTION OF THE INVENTION

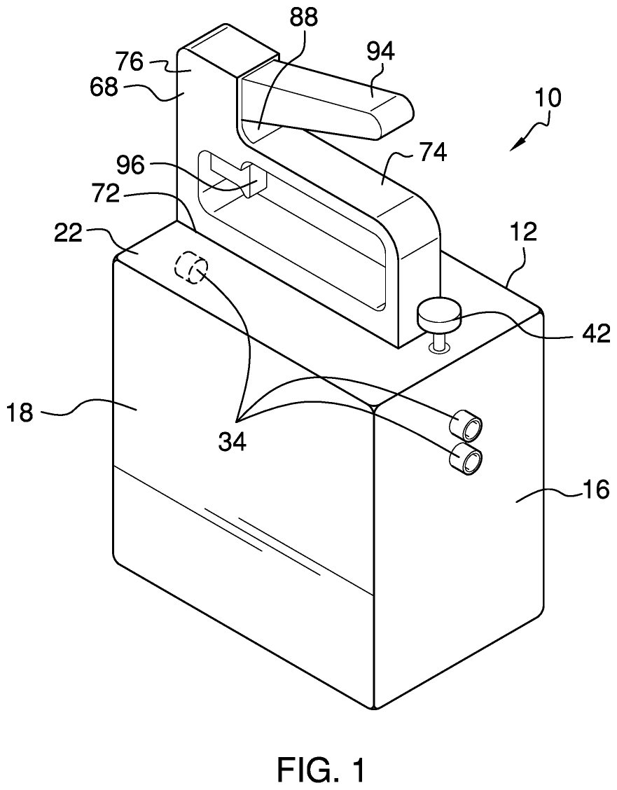

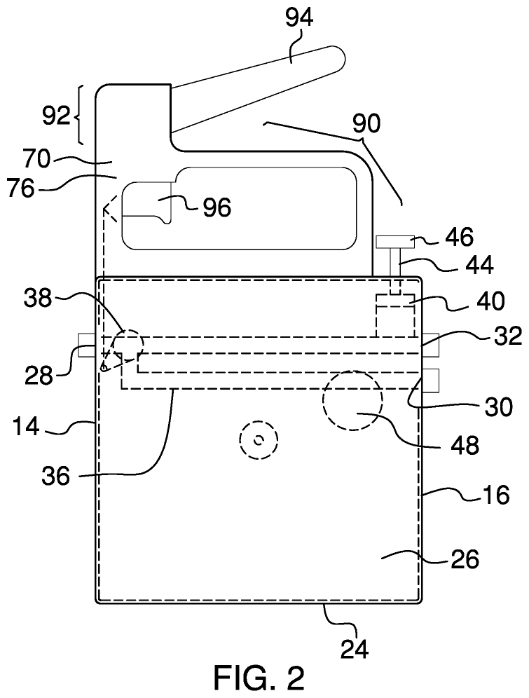

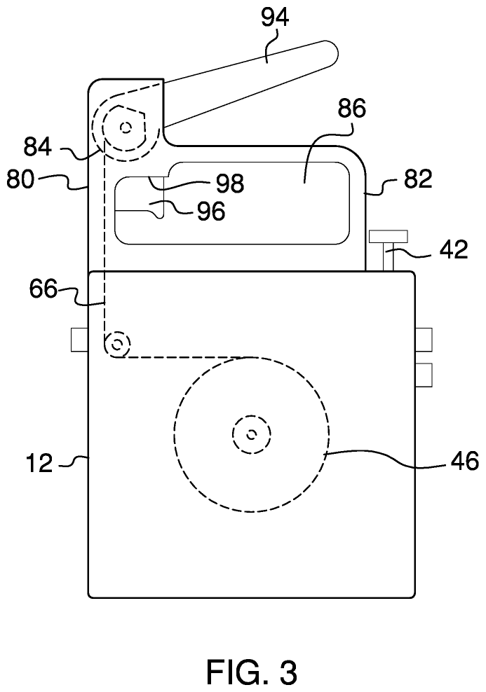

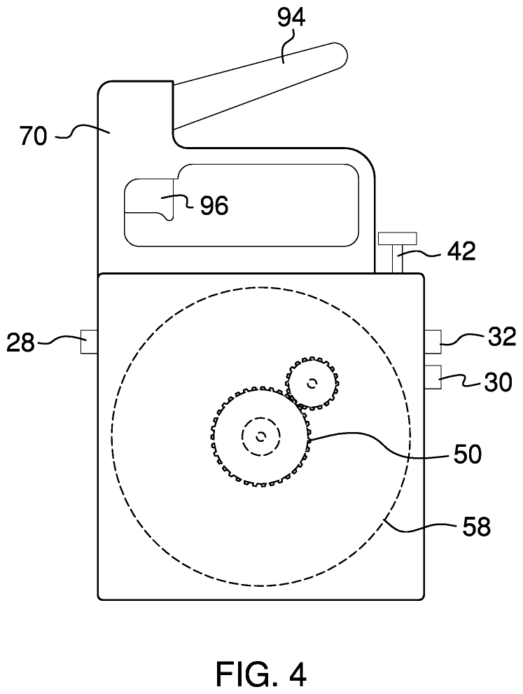

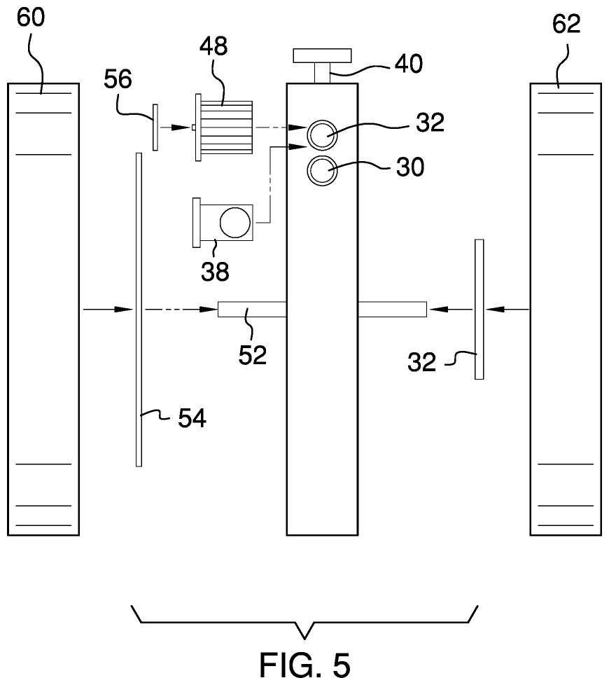

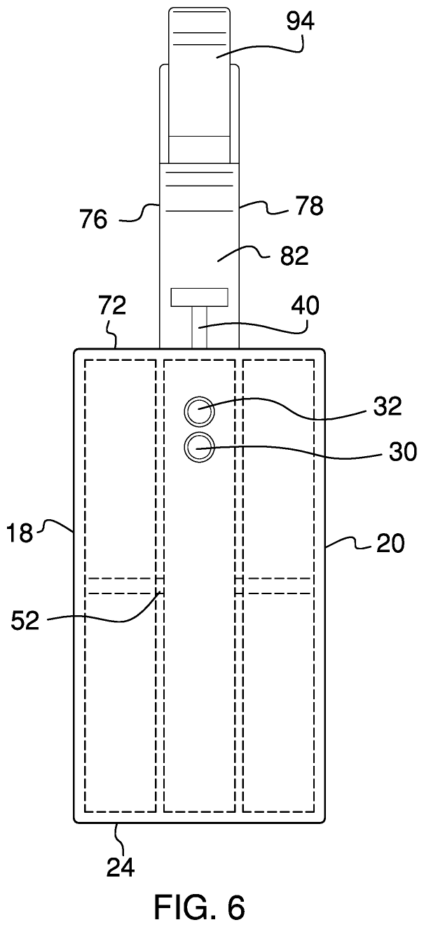

With reference now to the drawings, and in particular to FIGS. 1 through 6 thereof, a new pump device embodying the principles and concepts of an embodiment of the disclosure and generally designated by the reference numeral 10 will be described.

As best illustrated in FIGS. 1 through 6, the momentum pump apparatus 10 generally comprises a pump housing 12 having a housing front side 14, a housing back side 16, a housing left side 18, a housing right side 20, a housing top side 22, and a housing bottom side 24 defining a housing inside 26. The housing front side 14 has a fill aperture 28 extending through to the housing inside 26. The housing back side 16 has a supply aperture 30 and a return aperture 32 extending through to the housing inside 26. Each of the supply aperture 30, the return aperture 32, and the fill aperture 28 may have a one way valve 34 configured to receive a hose. The hoses connected to the supply aperture 30 and the return aperture 32 are placed into a fluid supply and the hose connected to the fill aperture 28 is directed towards a fluid receptacle.

A fluid line 36 is coupled within the pump housing 12. The fluid line 34 is in fluid communication with the supply aperture 30, the fill aperture 28, and the return aperture 32. A two-way valve 38 may be coupled to the fluid line 36. The two-way valve 38 is in operational communication with the fluid line 34 to direct fluid either to the fill aperture 28 or to the return aperture 32. A primer 40 may be coupled to the fluid line 34. The primer 40 may include a primer button 42 having a button shaft 44 extending through the housing top side 22 and a circular button head 46. The primer 40 is in operational communication with the fluid line 34 adjacent the return aperture 32 to draw fluid towards the return aperture 32.

A pump 48 is coupled within the pump housing 12 and is in fluid communication with the fluid line 36 to bring fluid from the supply aperture 30 to the fill aperture 28 or the return aperture 32 depending on the orientation of the two-way valve 38. A gear system 50 is coupled within the pump housing 12. The gear system 50 comprises a main shaft 52, a main gear 54 coupled to the main shaft, and a pump gear 56 coupled to the pump 48. The gear system 50 also includes a weighted disc 58 to maintain momentum once spinning. The weighted disc 58 may comprise a left weight half 60 and a right weight half 62 each coupled to the main shaft 52. A ratchet drive wheel 64 is coupled to the main shaft 52 and a drive pulley 66 is coupled to the ratchet drive wheel 64. The gear system 50 is in operational communication with the pump 48 so that as the drive pulley 66 is moved the pump 48 is engaged.

A handle assembly 68 comprises a handle frame 70 coupled to the housing top side 22. The handle frame 70 has a frame bottom side 72, a frame top side 74, a frame left side 76, a frame right side 78, a frame front side 80, and a frame back side 82 defining a frame inside 84. The frame left side 76 has a finger aperture 86 extending through the frame right side 78 configured to receive all of a user's fingers. The frame top side 74 has a lever aperture 88 extending through the frame inside 84. The handle frame 70 may have a guard portion 90 surrounding the finger aperture 86 and an extension portion 92 extending above the guard portion 90. The lever aperture 88 extends through the extension portion 92.

The handle assembly 68 further comprises a pump lever 94 coupled through the lever aperture 88 and is in operational communication with the drive pulley 66. The pump lever 94 may thus be depressed with the user's palm as the user's fingers are secured within the finger aperture 86. The pump lever 94 may be spring loaded to automatically return to a raised position after being depressed so it can be repeatedly squeezed to drive the pump 48.

A release trigger 96 may be coupled to the handle assembly 68. The release trigger 96 is coupled within a sidewall 98 of the finger aperture to be squeezed with the user's index finger. The release trigger 96 is in operational communication with the two-way valve 38. When the release trigger 96 is pulled it will route fluid to the fill aperture 28.

In use, the pump lever 94 is depressed to get the gear system 50 spinning. The primer button 42 is then depressed to draw fluid in through the supply aperture 30 to the pump 48. Once the fluid starts to flow through the return aperture 32, the release trigger 96 may be depressed to direct the flow to the fill aperture 28. The pump lever 94 is depressed again as the weighted disc 58 loses momentum.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A momentum pump apparatus comprising:
a pump housing having a housing front side, a housing back side, a housing left side, a housing right side, a housing top side, and a housing bottom side defining a housing inside, the housing front side having a fill aperture extending through to the housing inside, the housing back side having a supply aperture extending through to the housing inside;
a fluid line coupled within the pump housing, the fluid line being in fluid communication with the supply aperture and the fill aperture;
a pump coupled within the pump housing, the pump being in fluid communication with the fluid line to bring fluid from the supply aperture to the fill aperture;
a gear system coupled within the pump housing, the gear system including a weighted disc to maintain momentum once spinning, the gear system being in operational communication with the pump; and
a handle assembly coupled to the pump housing, the handle assembly being in operational communication with the gear system to operate the pump.

2. The momentum pump apparatus of claim 1 further comprising the gear system comprising a main shaft, a main gear coupled to the main shaft, and a pump gear coupled to the pump, the weighted disc being coupled to the main shaft.

3. The momentum pump apparatus of claim 2 further comprising the weighted disc comprising a left weight half and a right weight half.

4. The momentum pump apparatus of claim 1 further comprising the gear system comprising a ratchet drive wheel and a drive pulley, the handle assembly being in operational communication with the drive pulley.

5. The momentum pump apparatus of claim 1 further comprising the handle assembly comprising a handle frame coupled to the housing top side, the handle frame having frame bottom side, a frame top side, a frame left side, a frame right side, a frame front side, and a frame back side defining a frame inside, the frame left side having a finger aperture extending through the frame right side, the frame top side having a lever aperture extending through the frame inside, a pump lever being coupled through the lever aperture and being in operational communication with the gear system.

6. The momentum pump apparatus of claim 5 further comprising the handle frame having a guard portion surrounding the finger aperture and an extension portion extending above the guard portion, the lever aperture extending through the extension portion.

7. The momentum pump apparatus of claim 1 further comprising the housing back side having a return aperture; the fluid line being in operational communication with the return aperture; a two-way valve coupled to the fluid line and being in operational communication with the fluid line to direct fluid either to the fill aperture or to the return aperture; a primer coupled to the fluid line and being in operational communication with the fluid line adjacent the return aperture to draw fluid towards the return aperture.

8. The momentum pump apparatus of claim 7 further comprising a release trigger coupled to the handle assembly, the release trigger being in operational communication with the two-way valve.

9. The momentum pump apparatus of claim 8 further comprising the release trigger being coupled within a finger aperture of a handle frame of the handle assembly.

10. The momentum pump apparatus of claim 7 further comprising the primer including a primer button extending through the housing top side.

11. A momentum pump apparatus comprising:
a pump housing having a housing front side, a housing back side, a housing left side, a housing right side, a housing top side, and a housing bottom side defining a housing inside, the housing front side having a fill aperture extending through to the housing inside, the housing back side having a supply aperture and a return aperture extending through to the housing inside;
a fluid line coupled within the pump housing, the fluid line being in fluid communication with the supply aperture, the fill aperture, and the return aperture;
a two-way valve coupled to the fluid line, the two-way valve being in operational communication with the fluid line to direct fluid either to the fill aperture or to the return aperture;
a primer coupled to the fluid line, the primer including a primer button extending through the housing top side, the primer being in operational communication with the fluid line adjacent the return aperture to draw fluid towards the return aperture;
a pump coupled within the pump housing, the pump being in fluid communication with the fluid line to bring fluid from the supply aperture to the fill aperture;
a gear system coupled within the pump housing, the gear system including a weighted disc to maintain momentum once spinning, the gear system comprising a main shaft, a main gear coupled to the main shaft, and a pump gear coupled to the pump, the weighted disc comprising a left weight half and a right weight half each coupled to the main shaft, a ratchet drive wheel being coupled to the main shaft and a drive pulley being coupled to the ratchet drive wheel, the gear system being in operational communication with the pump;
a handle assembly coupled to the pump housing, the handle assembly comprising a handle frame coupled to the housing top side, the handle frame having frame bottom side, a frame top side, a frame left side, a frame right side, a frame front side, and a frame back side defining a frame inside, the frame left side having a finger aperture extending through the frame right side, the frame top side having a lever aperture extending through the frame inside, the handle frame having a guard portion surrounding the finger aperture and an extension portion extending above the guard portion, the lever aperture extending through the extension portion, a pump lever being coupled through the lever aperture and being in operational communication with the drive pulley; and
a release trigger coupled to the handle assembly, the release trigger being coupled within a sidewall of the finger aperture of the handle frame, the release trigger being in operational communication with the two-way valve.
